(19) United States
(12) Patent Application Publication
(10) Pub. No.: US 2002/0062256 A1
(43) Pub. Date: May 23, 2002

(54) System for selling goods

(76) Inventor: Kaoru Shimamura, Kawasaki (JP)

Correspondence Address: STAAS & HALSEY LLP, 700 11TH STREET, NW, SUITE 500, WASHINGTON, DC, 20001, US

(21) Appl. No.: 09/809,109

(22) Filed: Mar. 16, 2001

(30) Foreign Application Priority Data
Nov. 17, 2000 (JP) 2000-351776

(51) Int. Cl. G06F 17/60

(52) U.S. Cl. 705/26

(57) ABSTRACT

A system for selling goods a purchaser desired to purchase via a network. This system has: a table in which units of a variety of goods according to the number of goods and ranges to which the units are applied are stored; a section detecting the number of goods to be purchased on the basis of an identification code of one or more goods received from the purchaser; a section reading at least one unit applied to the goods to be purchased from the table on the basis of the detected number of goods; and a section of calculating the number of goods belonging to the range to which the read at least one unit is applied and calculating a purchase price by using the read unit and the calculated number of goods.

### BACKGROUND OF THE INVENTION

1. Field of the Invention

The present invention relates to a system for selling goods through a network.

2. Description of the Related Art

Font environments used in the operating systems (OS) such as Windows and Linux include an internal character font and an external character font (user defined character font). The internal character font is created according to a determined standard such as JIS or Unicode. The code of the external character font is originally defined by the user. Within the range of codes determined by an OS, assignment of character codes in the external character fonts and the number of characters to be accommodated can be originally determined.

Generally, the necessity of the external character font occurs at an initial stage after a system is introduced. It may also occur as the system operation continues. When an external character font becomes necessary, the user of the system has to purchase the necessary external character font from a seller.

Conventionally, when the purchaser purchases an external character font, the seller presents the price per external character font (unit) to the purchaser. The purchase price is calculated by multiplying the presented unit by the number of external character fonts (number of characters) to be purchased by the purchaser.

The conventional method has, however, the following problems. When the number of characters to be purchased by the purchaser is small, the purchase price is not so high. When the purchaser purchases a number of external character fonts, however, the purchase price becomes high. Consequently, the purchaser and the seller negotiate to determine the price, but the negotiation does not always end successfully.

### SUMMARY OF THE INVENTION

An object of the invention is to provide a goods selling system capable of providing goods at a reasonable price for the purchaser.

In order to achieve the object, the invention employs the following configuration.

According to a first aspect of the invention, a system for selling goods through a network, the goods being a variety of elements which are different from each other and are sold one by one, the system has: a unit storage section storing a unit of the variety of elements according to the number of the elements and ranges to each of which a unit is applied; a detecting section detecting the number of elements to be purchased on the basis of information of one or more elements to be purchased which is received from a purchaser; a reading section reading at least one unit applied to the element to be purchased on the basis of the detected number of element from the unit storage section; a first calculating section calculating the number of elements belonging to a range to which the read at least one unit is applied; and a second calculating section calculating the purchase price by using the read at least one unit and the number of elements calculated.

A second aspect of the invention relates to a system for selling goods through a network, having: a storage section storing a goods purchase record of a purchaser; and a calculating section calculating a purchase price of goods to be purchased which is received from the purchaser on the basis of the purchase record of the purchaser stored in the storage section.

According to the second aspect, the sales price (purchase price of a purchaser) of goods designated as an object to be purchased by the purchaser can be determined on the basis of a goods purchase record in the past of the purchaser.

### BRIEF DESCRIPTION OF THE DRAWINGS

FIG. 1 is a schematic diagram of a goods selling system of the invention;

FIG. 2 is a block diagram of a terminal shown in FIG. 1;

FIG. 3 is a block diagram of a selling server shown in FIG. 1;

FIG. 4 is an explanatory diagram of a purchaser information table;

FIG. 5 is an explanatory diagram of a purchase record table;

FIG. 6 is an explanatory diagram of a step-down price table;

FIG. 7 is an explanatory diagram of a goods data purchase record table;

FIG. 8 is an explanatory diagram of an identification (ID) code storage table;

FIG. 9 is an explanatory diagram of a supply information table;

FIG. 10 is an explanatory diagram of a goods information table;

FIGS. 11A and 11B are diagrams each showing an example of a goods file;

FIG. 12 is a diagram showing a display example of a purchaser registration screen;

FIG. 13 is a diagram showing a display example of a log-in screen;

FIG. 14 is a diagram showing a display example of a goods selection screen;

FIG. 15 is a diagram showing a display example of a goods data selection screen;

FIG. 16 is a diagram showing a display example of a quotation screen;

FIG. 17 is a flowchart showing the procedure of purchase;

FIG. 18 is a sequence chart showing the details of registration of a purchaser;

FIG. 19 is a sequence chart showing the details from log-in to presentation of quotation;

FIG. 20 is a sequence chart showing the details from payment to supply of goods;

FIG. 21 is an explanatory diagram of a purchase record table in a second embodiment;

FIG. 22 is an explanatory diagram of a step-down price table in the second embodiment;

FIG. 23 is an explanatory diagram of a goods data purchase record table in the second embodiment;

FIG. 24 is an explanatory diagram of an ID code storage table in the second embodiment;

FIG. 25 is an explanatory diagram of a supply information table in the second embodiment;

FIG. 26 is an explanatory diagram of a goods information table in the second embodiment;

FIG. 27 is a diagram showing a book file;

FIG. 28 is a diagram showing an another example of a book file;

FIG. 29 is an explanatory diagram of a supply screen; and

FIG. 30 is an explanatory diagram of a supply information table.

### DETAILED DESCRIPTION OF THE PREFERRED EMBODIMENTS

Embodiments of the invention will be described hereinbelow with reference to the drawings. The embodiments are examples of the invention, and the invention is not limited to the embodiments.

First Embodiment

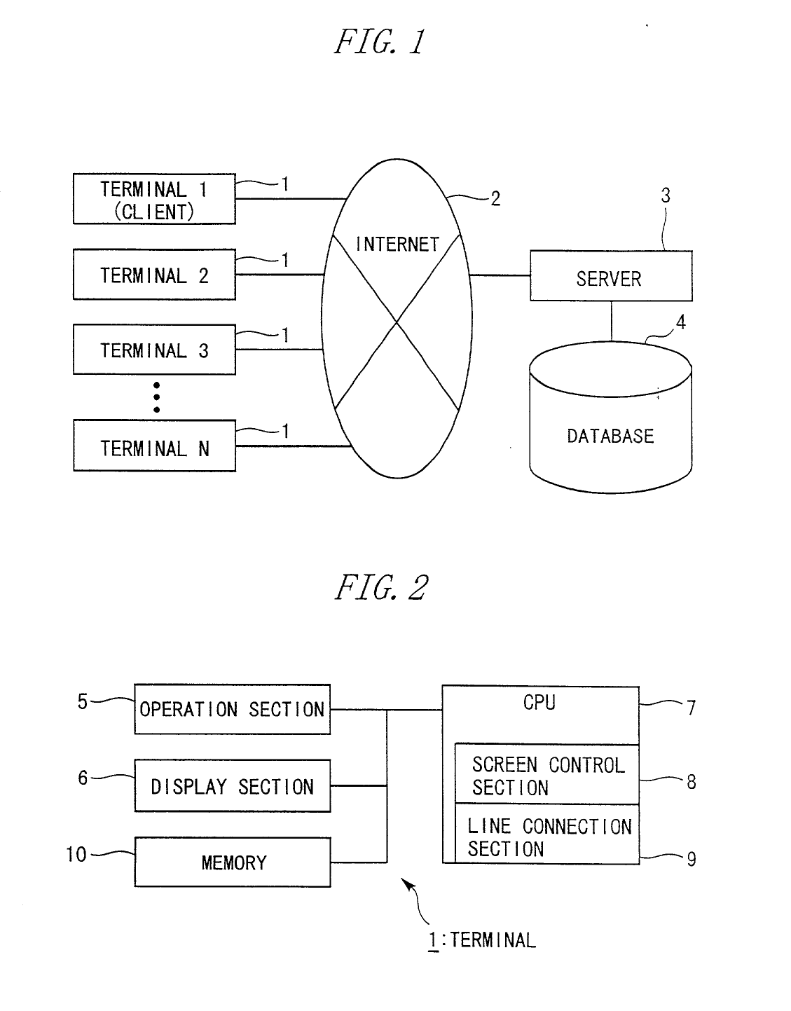

FIG. 1 is a schematic diagram of a system for selling goods in a first embodiment. As shown in FIG. 1, the system includes at least one terminal 1 used by a purchaser (orderer) of goods, a server 3 connected to a database 4 having goods data, purchaser data, and the like, and lines (network) 2 connecting the terminals 1 and the server 3. In the example, (n) terminals 1 are shown and the Internet is used as the network 2.

Each of the terminals 1 takes the form of a computer such as a personal computer (PC), workstation (WS), or mobile computer. Each of the terminals 1 is connected to the network 2 and displays various information sent from the server 2 by using the World Wide Web (WWW) or the like onto the screen of a display by a Web browser or the like.

The server 3 takes the form of a PC, WS, dedicated server machine, or the like. The server 3 manages a WWW site (also called a “home page”) for selling goods. The server 3 provides sales information of goods through the WWW site to the terminal 1 which accesses the WWW site. The server 3 accepts an order of goods from the terminal 1. The server 3 calculates the purchase price on the basis of a purchase record of the purchaser (orderer) and a price list.

In the example, the goods is an external character font set of which codes can be originally defined by the user. The external character font set is stored in a file. The server 3 has files of a variety of external character font sets (hereinbelow, also described as “goods file” as necessary). Each file of an external character font set includes data of a variety of external character fonts (hereinbelow, also described as “goods data” as necessary). The external character fonts in a file are different from each other. Each external character font corresponds to an “element of a commodity” or “a commodity”.

Although “a commodity” is defined as “a set of elements” in the first aspect of the invention, “an element” itself is “a commodity” in the second aspect. That is, a commodity of the invention denotes both “a set of elements” and “an element itself” (a font (first embodiment) and data in a chapter section (second embodiment) in embodiments).

The purchaser can purchase a goods file itself (all of external character fonts in an external character font set) or one or more external character fonts selected from the external character font set. That is, the purchaser can purchase each of the goods data in the goods file separately. In the case where each goods data is sold separately, the goods data is sold at a predetermined unit irrespective of the contents.

FIG. 2 is a configuration diagram of the terminal 1 shown in FIG. 1. In FIG. 2, the terminal 1 has an operation section 5, a display section 6, a CPU (Central Processing Unit) 7, a screen control section 8, and a line connection section 9 which are connected to each other via a bus.

The operation section 5 is constructed by using an input device such as a keyboard, or pointing device (mouse, joystick, flat point, or trackball). The operation section 5 is used by the user to enter a command and data to operate the terminal 1.

The display section 6 is a display such as a cathode ray tube (CRT), liquid crystal display (LCD), or plasma display and displays an operation screen or the like of the terminal 1.

The CPU 7 loads various programs stored in an auxiliary storage (not shown) connected to the terminal 1 into a memory 10 and executes the programs. The CPU 7 controls the screen control section 8 and the line connection section 9 by the programs.

The screen control section 8 displays operation screen information such as HTML (Hypertext Markup Language) data used by the WWW, which is sent from the server 3, and controls commands and data entered from the operation section 5. The screen control section 8 corresponds to a transmitting/receiving section, a transmitting section, a receiving section, and a display controlling section in the invention.

The line connection section 9 connects the terminal 1 to a line (network 2), and controls data transmission/reception using a communication protocol such as the HTTP (Hypertext Transfer Protocol) or FTP (File Transfer Protocol) used in the WWW.

The memory 10 is used as a work area of the CPU 7 and a video memory for holding data to be displayed on the display section 6. For example, the memory 10 temporarily stores data entered from the operation section 5 by referring to the operation screen displayed on the display section 6.

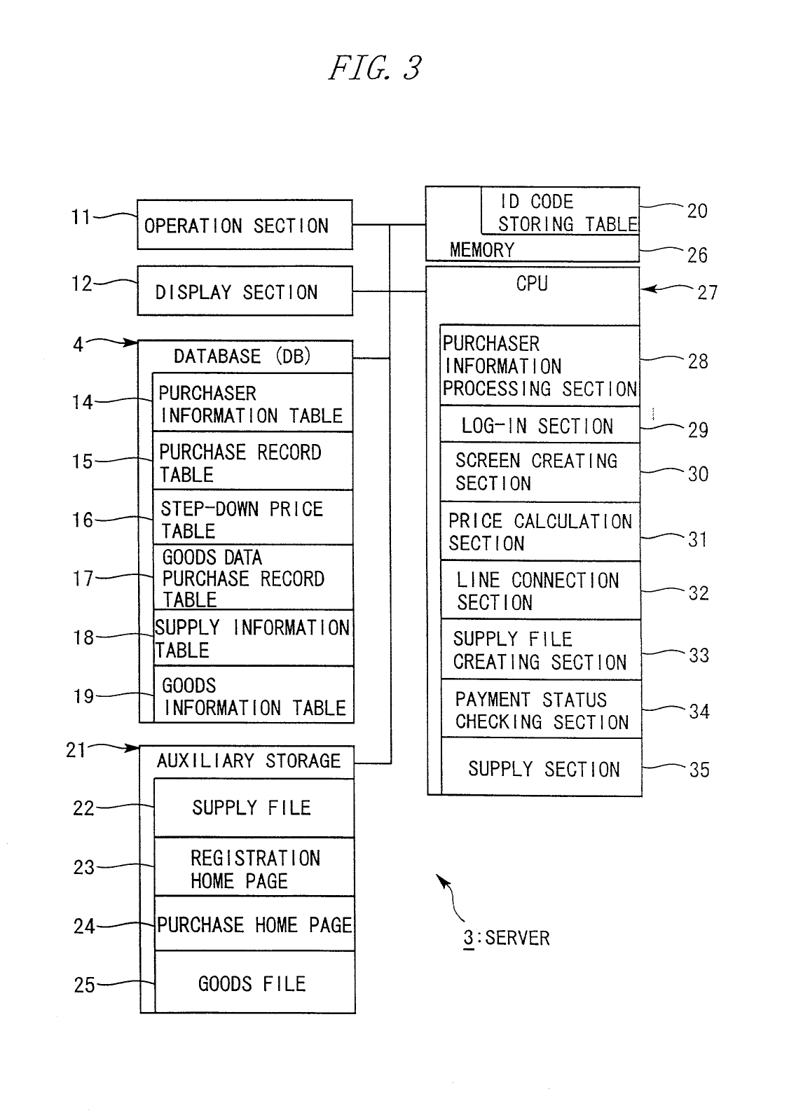

FIG. 3 is a configuration diagram of the server 3 shown in FIG. 1. In FIG. 3, the server 3 has an operation section 11, a display section 12, a database (DB) 4, an auxiliary storage 21, a memory 26, and a CPU 27 which are connected to each other via a bus. The operation section 11 and the display section 12 have almost the same configurations of the operation section 5 and the display section 6 shown in FIG. 2, respectively. The operation section 11 and the display section 12 of the server 3 are not always indispensable elements for carrying out the invention in association with the system configuration which will be described hereinlater.

The DB 4 holds a table 14 for storing purchaser information, a table 15 for storing purchase record information, a table 16 for storing step-down price information, a table 17 for storing purchase record information of goods data, a table 18 for storing supply information, and a table 19 for storing goods information.

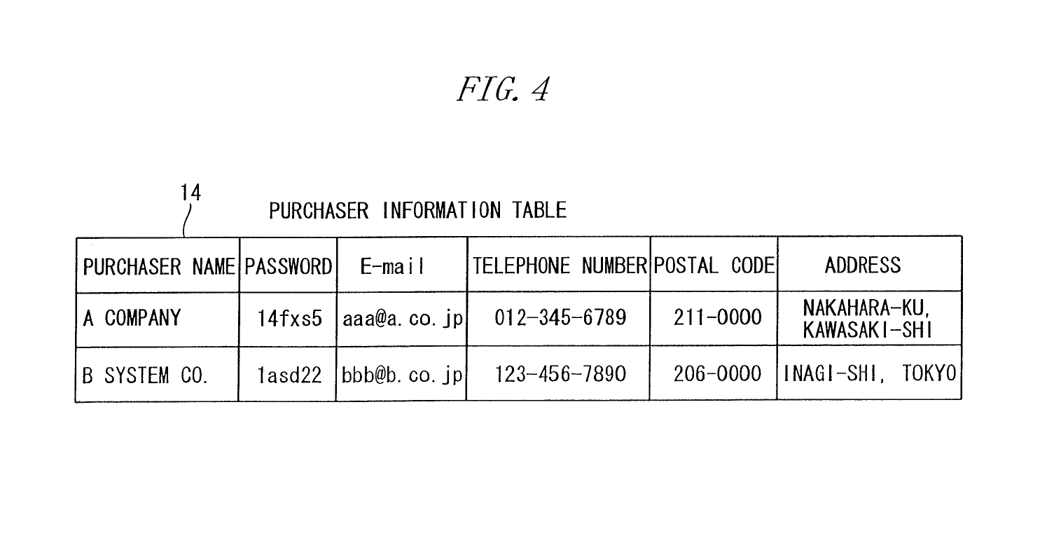

FIG. 4 is an explanatory diagram of the table 14. The table 14 holds information of a purchaser (purchaser information) who purchases goods by using the system. The purchaser information includes log-in information (account information) and personal information of the purchaser. The log-in information is information necessary to log in a WWW site (called “sales site”) provided by the server 3 and is, for example, purchaser name (user name) and a password. The personal information is information regarding the profile of the purchaser and includes, for example, purchaser name and a contact of the purchaser.

In the example shown in FIG. 4, the table 14 holds record of purchaser information for each purchaser. Each record includes, as elements, purchaser name, a password, an electronic mail (E-mail) address, telephone number, postal code, and address.

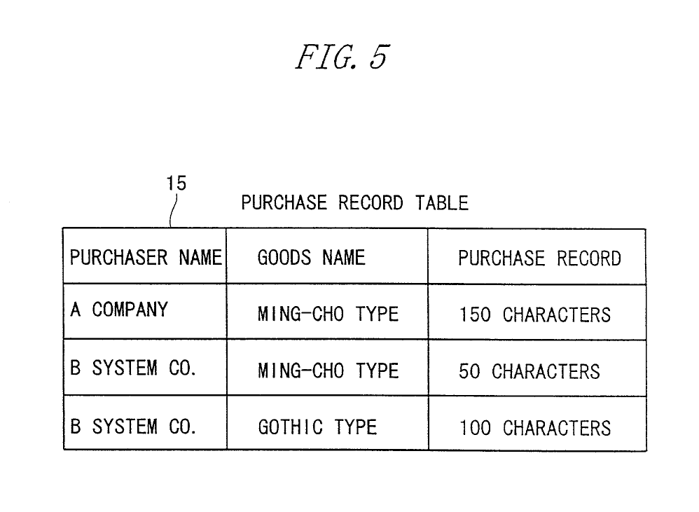

FIG. 5 is an explanatory diagram of the table 15. The table 15 holds information of a purchase record of a purchaser by goods. The purchase record (purchase state) indicates the number of elements in goods purchased by the purchaser in the past, that is, the number of purchased external character fonts (cumulative total) in a variety of external character fonts included in the external character font set purchased by the purchaser in the past.

The table 15 stores purchase records managed according to the purchasers and goods. The purchase record includes, as elements, purchaser name, goods name, and the above-described purchase record. The table 17 corresponds to a purchase record storage section of the invention.

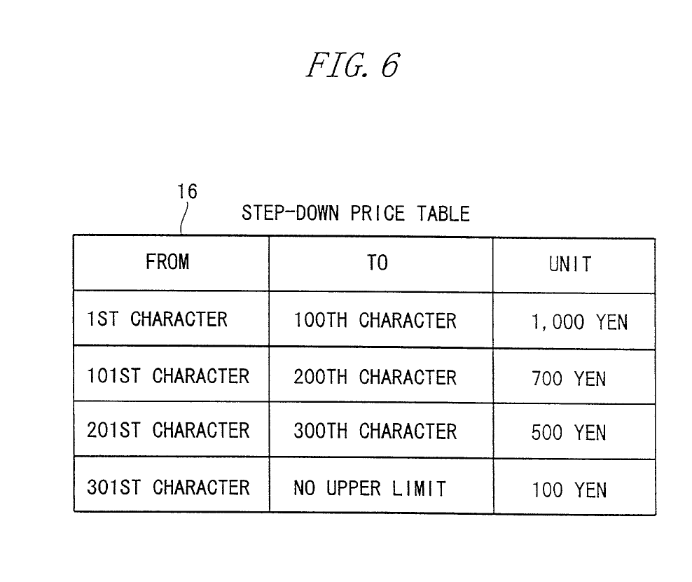

FIG. 6 is an explanatory diagram of the table 16. The table 16 holds information of definition of a unit of an external character font according to the purchase record of the purchaser. That is, the table 16 holds a unit defined according to a range of the number of external character fonts.

Specifically, when the number (cumulative total) of external character fonts purchased by a purchaser lies in the range from 1 to 100, the unit is defined as 1,000 yen. When the number lies in the range from 101 to 200, the unit is defined as 700 yen. When the number lies in the range from 201 to 300, the unit is defined as 500 yen. When the number is 301 or larger, the unit is defined as 100 yen.

The table 16 corresponds to a unit storage section of the invention. In the embodiment, the same table 16 is used for a plurality of goods (external character font sets). Alternately, the table 16 may be prepared for each commodity (external character font set). The number of unit application ranges (unit ranges) is not limited to the above example (four) but can be set to an appropriate value.

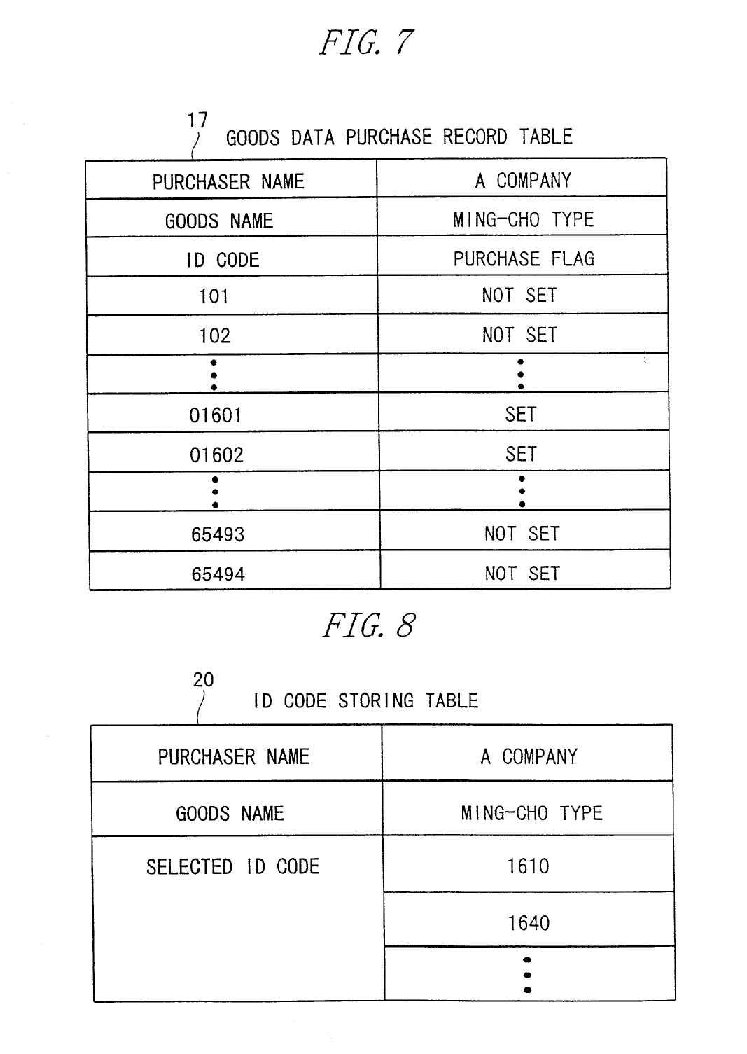

FIG. 7 is an explanatory diagram of the table 17. The table 17 is created for each purchaser and each commodity name. The table 17 holds information indicative of the presence or absence of a purchase record of each element in a specific commodity of a specific purchaser.

Specifically, each table 17 holds a purchase flag indicative of the presence or absence of a purchase record of the purchaser every identification information (identification code) of an element (external character font) in goods (external character font set).

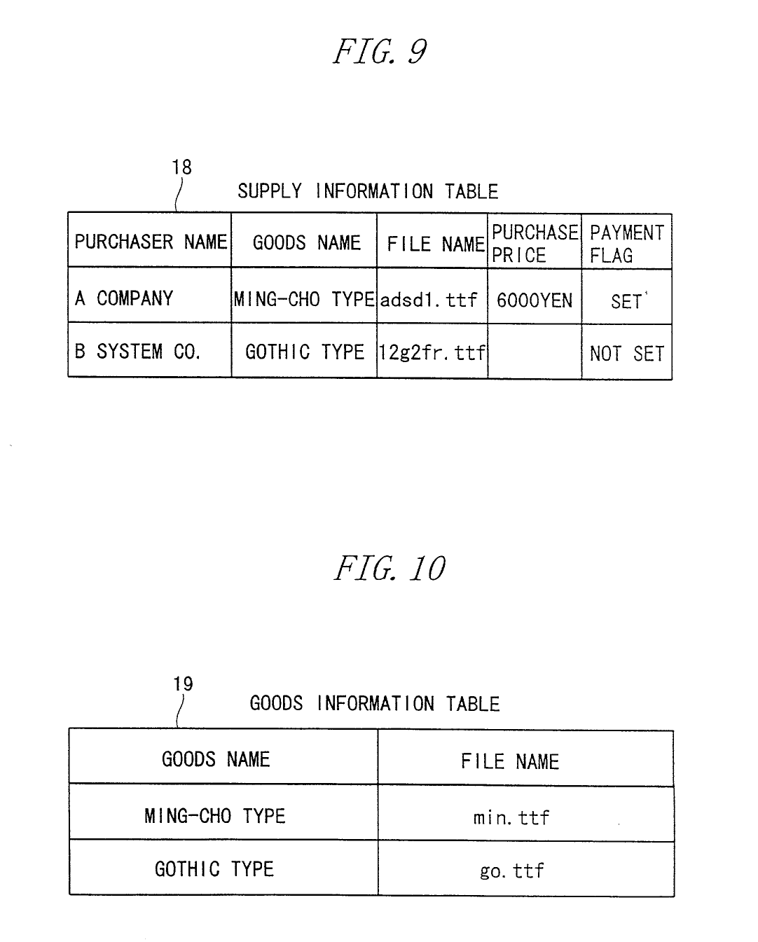

FIG. 9 is an explanatory diagram of the table 18. The table 18 holds at least one supply information record created for each purchaser and each commodity. The supply information record includes, as elements, purchaser name, goods name, file name of a supply file, purchase price, and payment flag indicating whether payment is made or not. The supply file includes at least one goods data supplied in response to the order of the purchaser.

FIG. 10 is an explanatory diagram of the table 19. The table 19 holds information of goods sold by the server 3. To be specific, the table 19 holds, as information of goods, goods name of the external character font set, and file name of the external character font set corresponding to the goods name (goods file name).

Referring again to FIG. 3, the auxiliary storage 21 holds a storage area 22 of a supply file, a storage area 23 of a registration home page, a storage area 24 of a purchase home page, and a storage area 25 of a goods file. The storage area 22 holds a file including at least one piece of goods data to be supplied to the purchaser, that is, a supply file.

In the storage area 23, information necessary for the terminal 1 to access the server 3 in a connection aspect such as the WWW is stored. To be more specific, in the storage area 23, data regarding the registration home page (HTML file, text file, image file, video file, sound file, and the like) is stored. The registration home page is a Web page used by the user of the terminal 1 to register himself/herself (including a corporation to which the user belongs) as a purchaser of the goods.

In the storage area 24, information necessary for the terminal 1 to access the server 3 in a connection aspect such as the WWW is stored. Specifically, the storage area 24 holds data (HTML file, text file, image file, video file, sound file, and the like) regarding a purchase home page (also described as “sales site”). The purchase home page is a Web page used by the user of the terminal 1 to purchase goods from the server 3.

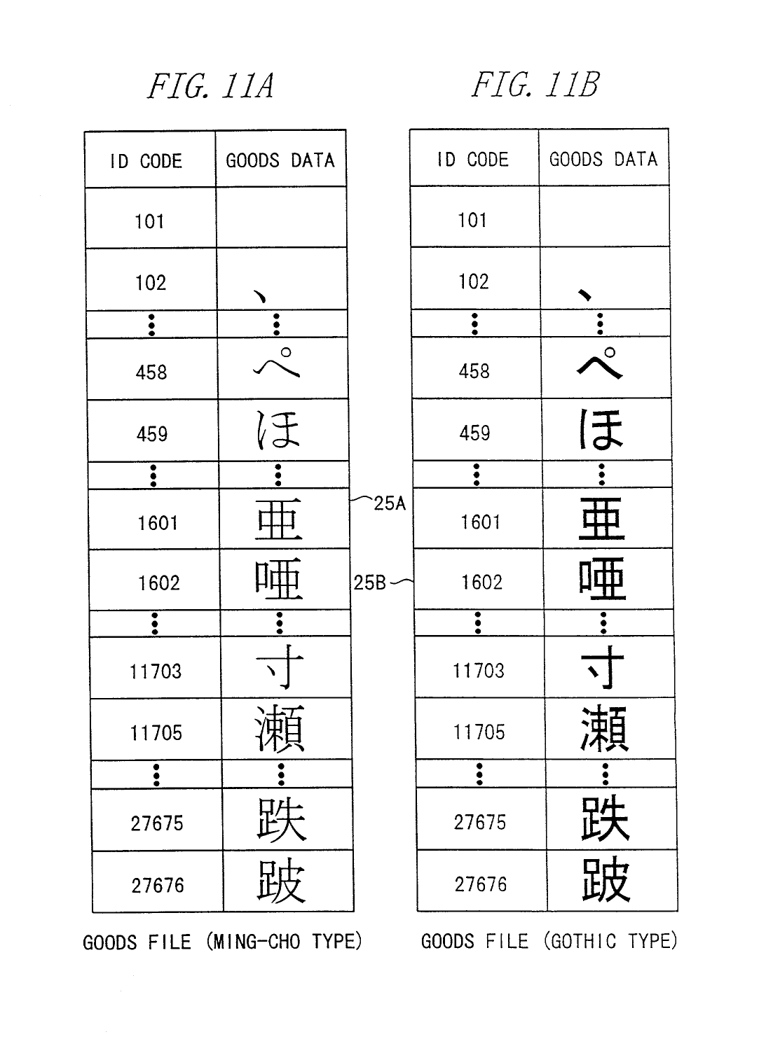

In the storage area 25, at least one goods file sold by the server 3 through the sales site is held. The storage area 25 corresponds to a data storage section of the invention. FIGS. 11A and 11B show examples of goods files stored in the storage area 25.

FIG. 11A shows a goods file 25A of a goods name “Ming-cho type” (file name “min.ttf”) and FIG. 11B shows a goods file 25B of a goods name “Gothic type” (file name “go.ttf”).

Each of the goods files 25A and 25B stores data (goods data) of a variety of external character fonts and identification (ID) codes assigned to the goods data in sets. In the example, as the ID codes, the same codes as the character codes of the external character fonts are used. Obviously, the ID codes and the character codes may be different from each other.

Referring again to FIG. 3, the memory 26 functions as a main memory of the server 3 and is used as a work area of the CPU 27 and a video memory for holding data for displaying information onto the display section 12.

For example, the memory 26 temporarily stores data read from the DB 4 and the auxiliary storage 21 in accordance with execution of the program by the CPU 27. On the memory 26, a table 20 for storing ID codes is created when a process regarding sales of goods is performed by the CPU 27.

FIG. 8 is an explanatory diagram of the table 20. The table 20 is created for each purchaser and each goods name. The table 20 holds ID codes of the external character fonts included in an order of the purchaser. That is, the table 20 holds an ID code of an external character font which has been selected as an external character font to be purchased by the purchaser but is not yet supplied to the purchaser in association with the purchaser name and the goods name.

Referring again to FIG. 3, by executing various programs recorded in the auxiliary storage 21, the CPU 27 realizes and controls a processing section 28 of purchaser information, a log-in section 29, a screen creating section 30, a price calculation section 31, a line connection section 32, a supply file creating section 33, a payment status checking section 34, and a supply section 35.

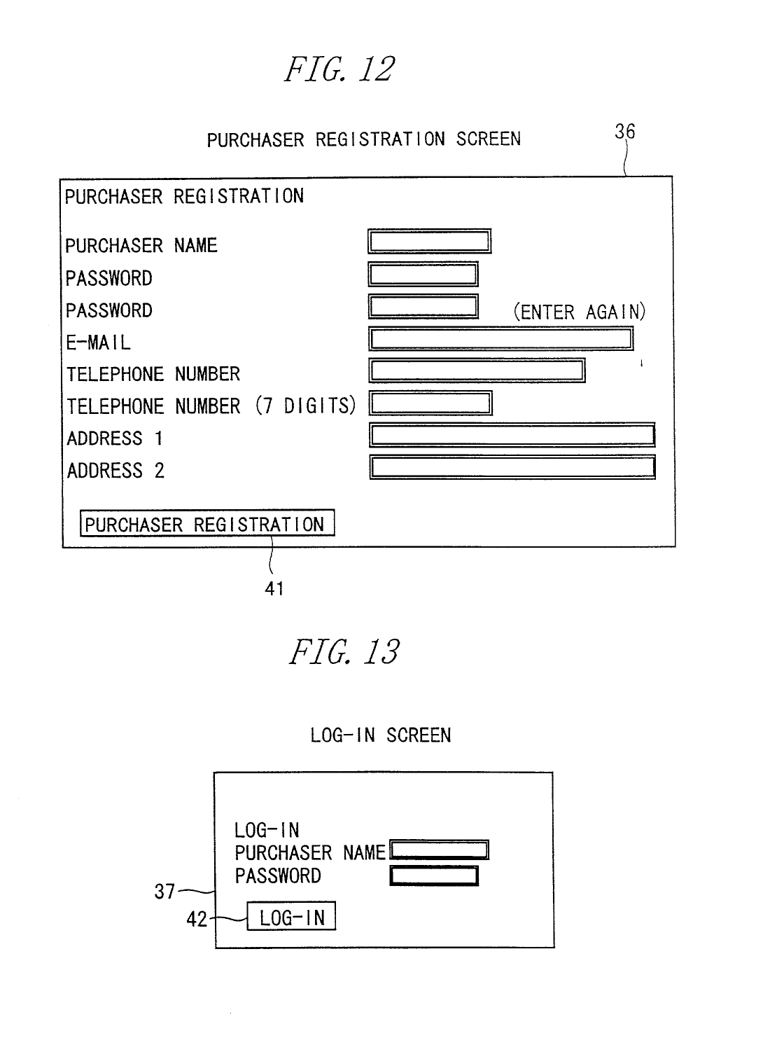

The processing section 28 stores information entered by using a purchaser registration screen (FIG. 12) into the purchaser information table 14 in the DB 4. The log-in section 29 performs authentication of the user necessary for the purchaser to go to a goods purchase page of the server 3.

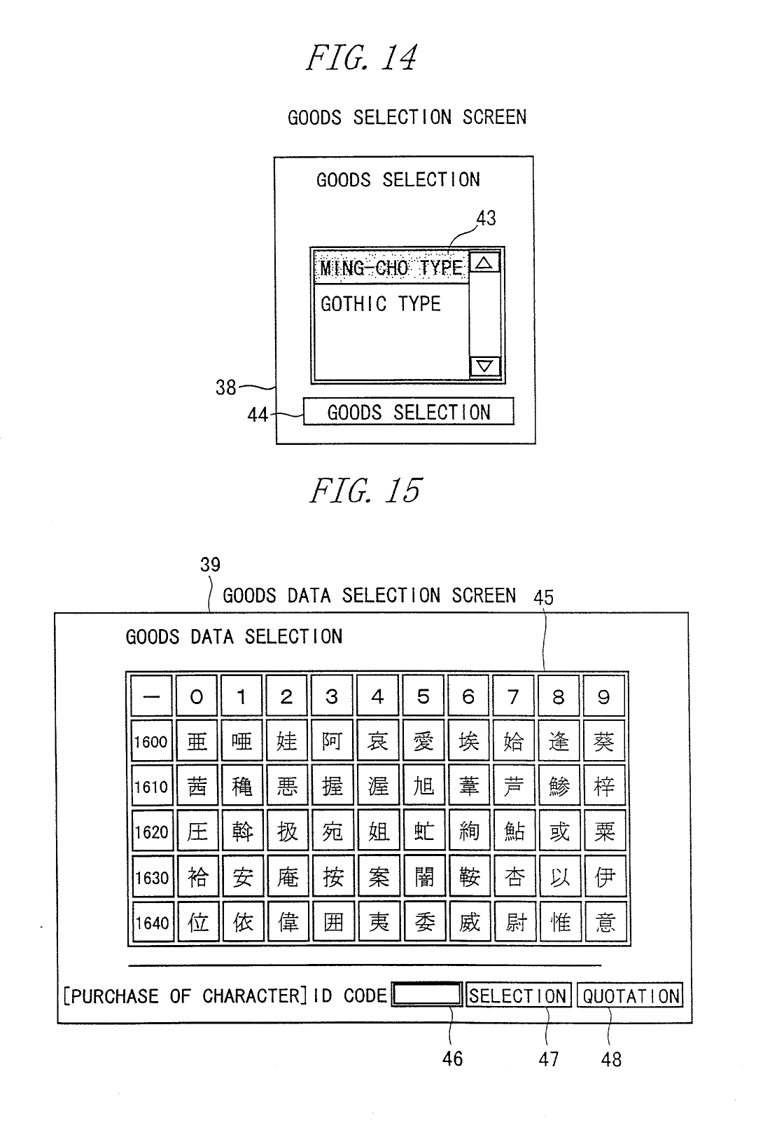

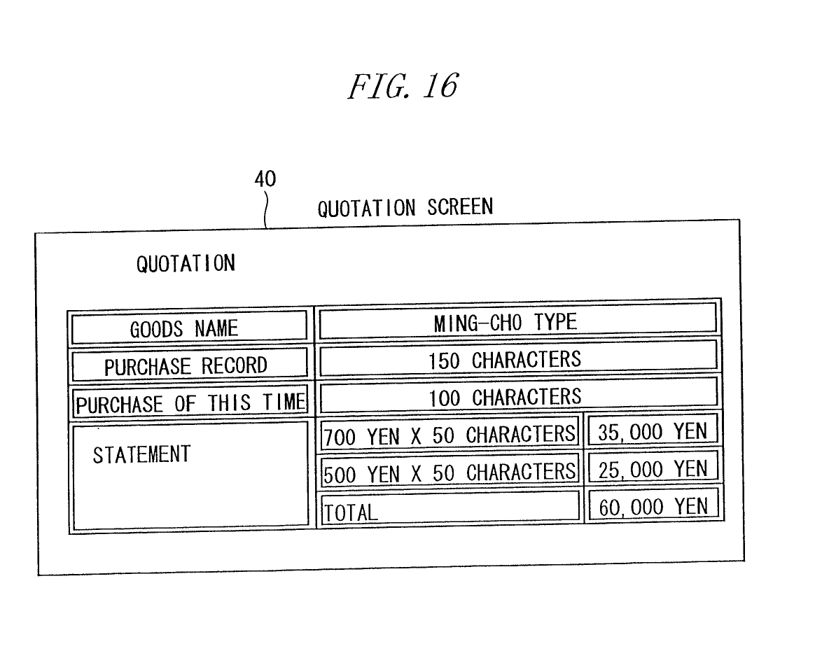

The screen creating section 30 creates screen information to be sent to the terminal 1. In the example, the screen creating section 30 creates information of a purchaser registration screen 36 (FIG. 12), a log-in screen 37 (FIG. 13), a goods selection screen 38 (FIG. 14), a goods data selection screen 39 (FIG. 15), and a quotation screen 40 (FIG. 16).

FIG. 12 is a diagram showing a display example of the purchaser registration screen 36. The registration screen 36 is an operation screen used by the purchaser to perform a registering work. The registration screen 36 has entry boxes of purchaser name, password created by the purchaser, E-mail address, telephone, postal code, and address as a plurality of boxes (registration form) for entering the personal information of the purchaser. The registration screen 36 has a registration button 41. The registration button 41 is a button to confirm the personal information entered in the entry boxes and send the confirmed personal information to the server 3.

FIG. 13 is a diagram showing a display example of the log-in screen 37. The log-in screen 37 is an operation screen for logging in the sales site. The log-in screen 37 has entry boxes of purchaser name (user name) and a password as a plurality of entry boxes for entering account information necessary for the purchaser to log in (access) the sales site. The log-in screen 37 has a log-in button 42. The log-in button 42 is a button to send the purchaser name (user name) and password entered in the entry boxes to the server 3.

FIG. 14 is a diagram showing a display example of the screen 38. The screen 38 is an operation screen used by the purchaser to select goods to be purchased. The screen 38 has a display area 43 for displaying a list of goods names, and a goods selection button 44. In the display area 43, a list of names of goods which are sold in the sales site (or can be purchased by the purchaser) is displayed. The purchaser selects (designates) the name of goods the purchaser wishes to purchase among the goods names included in the list by operating the operation section 5. The goods selection button 44 is a button for transmitting the goods name selected by the purchaser to the server 3.

FIG. 15 is a diagram showing a display example of the screen 39. The screen 39 is an operation screen which is used by the purchaser to refer to the screen on which a list of goods data is displayed by the ID code, and to enter the ID code of goods data to be purchased to select the goods data.

The screen 39 has a display area 45 of the list of goods data, an ID code entry box 46, a selection button 47, and a quotation button 48. In the list of goods data displayed in the display area 45, goods data (external character fonts) included in the goods file corresponding to the goods name selected on the screen 38 is displayed with the identification codes.

In the entry box 46, the ID code of the goods data the purchaser wishes to purchase is entered. The selection button 47 is a button to confirm the goods selected by the purchaser. When the selection button 47 is clicked in a state where the ID code is entered in the input box 46, the goods data corresponding to the displayed ID code is determined as the selected goods data. The quotation button 48 is a button to enter an inquiry of the price of one or more goods data selected by the purchaser.

FIG. 16 is a diagram showing a display example of the quotation screen 40. The quotation screen 40 is an operation screen used by the purchaser to confirm the purchase price. On the quotation screen 40, goods name, purchase record (the number of external character fonts in the goods purchased in the past), the number of external character fonts to be purchased this time, and a billing statement are shown.

Referring again to FIG. 3, the price calculation section 31 calculates the purchase price of this time on the basis of the data held in the table 15 (FIG. 5) and the table 20 (FIG. 8). The line connection section 32 performs processes for connecting the server 3 to a line and enabling communications by the communication protocol such as HTTP or FTP of the WWW to be conducted. The price calculation section 31 corresponds to a detecting section, a reading section, a first calculating section, a second calculating section, an addition section, and a calculating section of the invention.

The supply file creating section 33 creates an electronic file (supply file) including goods data to be supplied to the purchaser on the basis of the data held in the ID code storing table 20 (FIG. 8). The creating section 33 may create a supply file including only goods data to be purchased this time or a supply file including goods data to be purchased this time and goods data purchased in the past.

When the purchaser made payment, the checking section 34 sets the corresponding payment flag in the supply information table 18 (FIG. 9) as “paid”. When the payment flag in the supply information table 18 (FIG. 9) is set as “paid”, the supply section 35 transfers the supply file stored in the storage area 22 in the auxiliary storage 21 to the terminal 1.

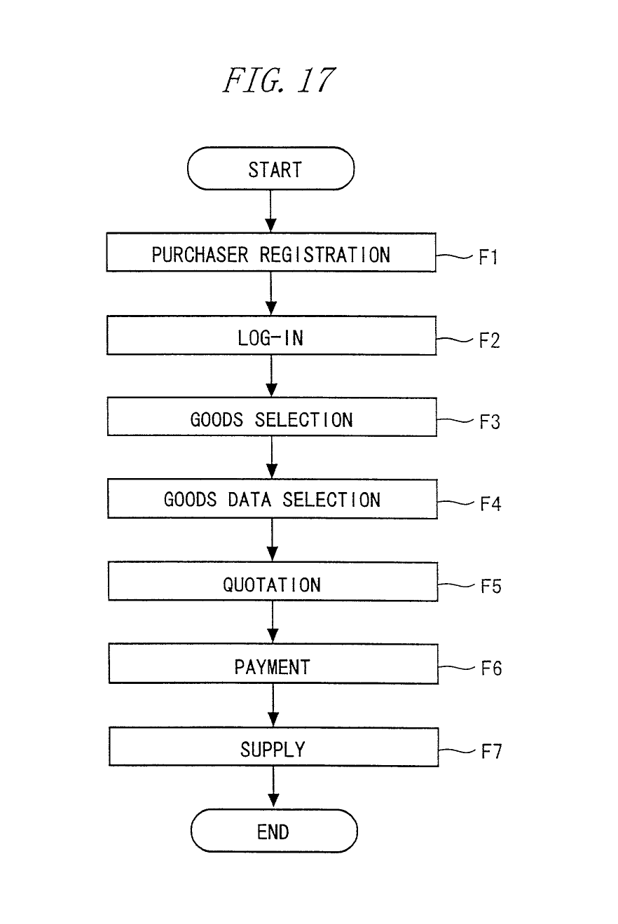

FIG. 17 is a flowchart for explaining the procedure of purchasing/selling goods by using the system shown in FIG. 1. First, the purchaser accesses the registration home page provided by the server 3 by operating the terminal 1 and registers himself/herself as a purchaser by using the registration screen 36 (FIG. 12) provided by the server 3 (phase F1).

The purchaser operates the terminal 1 to log in the sales site by using the log-in screen 37 (FIG. 13) provided by the server 3 (phase F2). The purchaser selects goods by using the screen 38 (FIG. 14) provided by the server 3 (phase F3).

Subsequently, the purchaser selects one or more goods data by using the screen 39 (FIG. 15) provided by the server 3 (phase F4). The quotation screen 40 (FIG. 16) according to the selection of the goods data is provided from the server 3 to the terminal 1, and the quoted price is displayed on the display section 6 (phase F5).

The purchaser refers to the quotation screen 40. When the purchaser acknowledges the presented quoted price, the purchaser pays the price (phase F6). Any of the following payment methods can be used; a method of debiting the account of the purchaser in a financial institution by using the account number of the financial institution or credit card number by the server 3; a method of transferring money to a financial institution of the seller from the purchaser; and a method of remitting money to the seller.

When the server 3 confirms the payment, the supply file including the selected one or more pieces of goods data is sent from the server 3 to the terminal 1, thereby supplying the supply file to the purchaser.

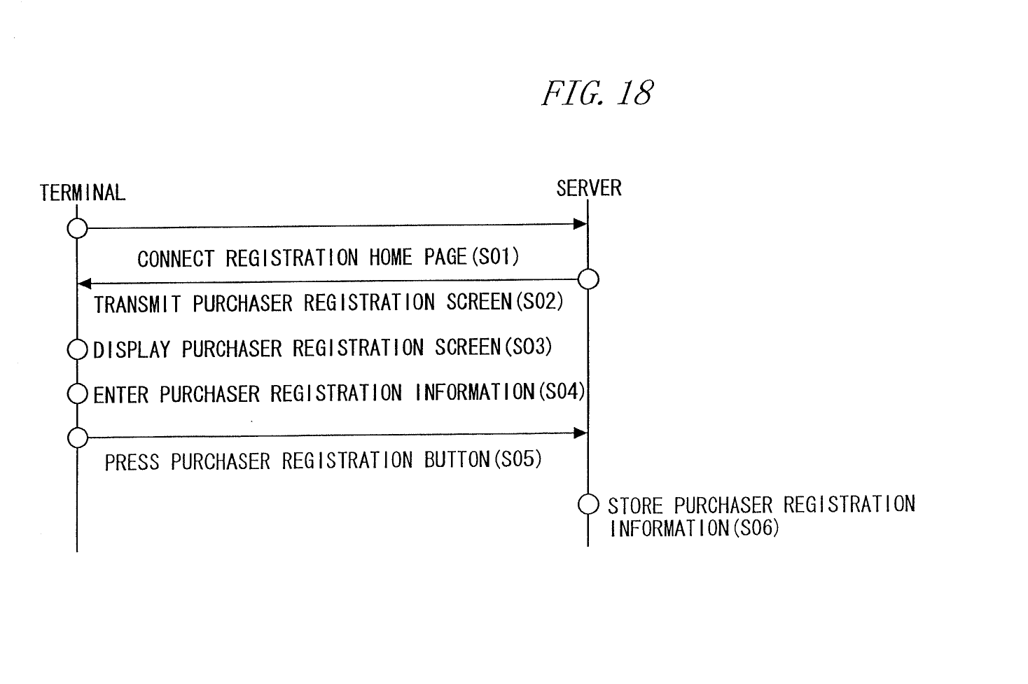

FIG. 18 is a sequence chart for explaining the details of the purchaser registration (phase F1) shown in FIG. 17. In FIG. 18, in the case of purchasing goods via the server 3 for the first time, the user registers himself/herself as a purchaser (member registration). For this purpose, first, the user connects the terminal 1 to the network 2 by using the operation section 5, and designates the URL (Uniform Resource Locator) of the registration home page. The line connection section 9 (FIG. 2) of the terminal 1 connects the terminal 1 to the server 3 via the network 2, and transmits an access request to the registration home page (step S01).

When the server 3 receives the access request from the terminal 1, the screen creating section 30 (FIG. 3) reads necessary information from the storage area 23 in the auxiliary storage 21, transfers it to the memory 26, and creates screen information of the registration screen 36. The screen creating section 30 transmits the created screen information to the corresponding terminal 1 via the line connection section 32 (step S02).

When the terminal 1 receives the screen information, the screen control section 8 (FIG. 2) displays the registration screen 36 (FIG. 12) on the display section 6 on the basis of the received screen information (step S03). The user refers to the displayed registration screen 36 and enters the purchaser information to the entry boxes in the screen 36 by using the operation section 5 (step S04). The entered purchaser information is temporarily stored in the memory 10 and is displayed on the screen 36.

After confirming that there is no error in the entered purchaser information, the purchaser clicks the registration button 41 by using the operation section 5. The screen control section 8 sends the purchaser information temporarily stored in the memory 10 to the server 3 via the line connection section 9 (step S05).

When the server 3 receives the purchaser information, the processing section 28 creates a record including the received purchaser information and stores the record into the table 14 (FIG. 4) in the DB 4 (step S06). In such a manner, the purchaser registration is made.

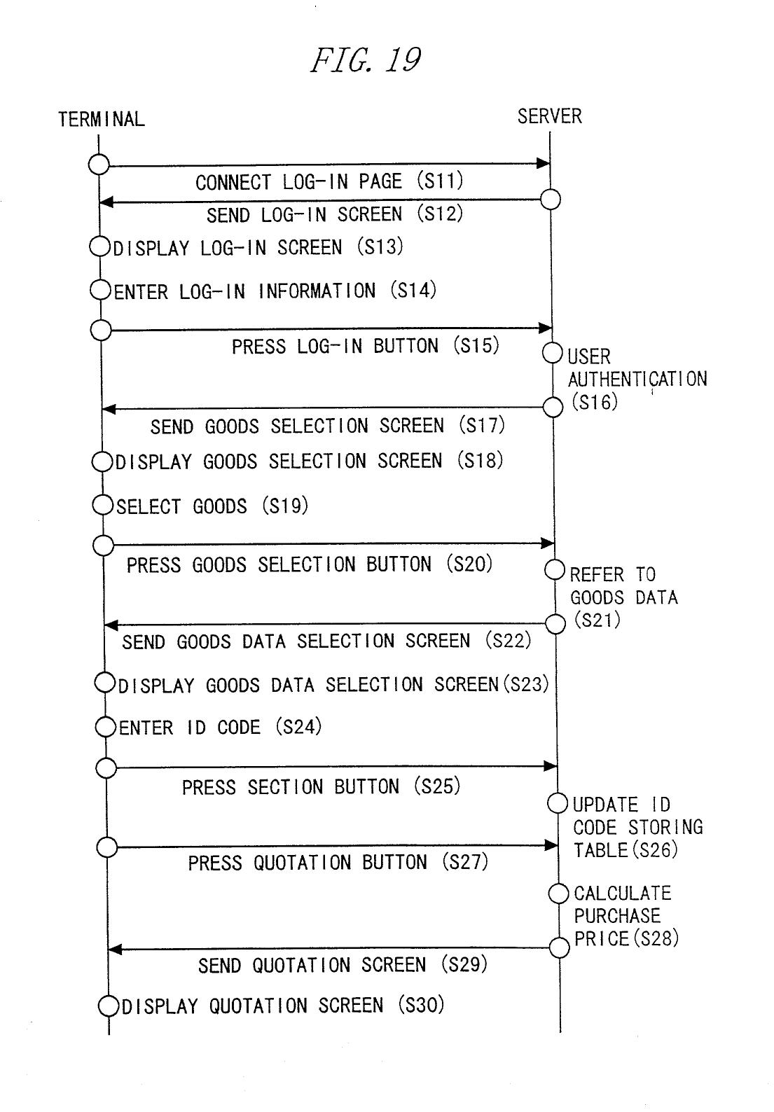

FIG. 19 is a sequence chart for explaining the details from the log-in (phase F2) to quotation (phase F5) shown in FIG. 17. In FIG. 19, in the case of purchasing goods, the purchaser operates the terminal 1 to access the sales site (purchase home page) provided by the server 3.

For this purpose, the purchaser operates the operation section 5 to connect the terminal 1 to the network 2, and designate the URL of the purchase home page. The line connection section 9 (FIG. 2) of the terminal 1 connects the terminal 1 to the server 3 via the network 2 and sends a request to access the sales site to the server 3 (step S11).

When the server 3 receives the access request from the terminal 1, the screen creating section 30 (FIG. 3) reads necessary information from the storage area 24 in the auxiliary storage 21, transfers it to the memory 26, and creates screen information of the log-in screen 37. After creating the screen information, the screen creating section 30 sends the created screen information to the corresponding terminal 1 via the line connection section 32 (step S12).

When the terminal 1 receives the screen information, the screen control section 8 (FIG. 2) displays the log-in screen 37 (FIG. 17) onto the display section 6 on the basis of the received screen information (step S13). The purchaser refers to the displayed log-in screen 37 and enters the purchaser name and password (step S14). The entered purchaser name and password are temporarily stored in the memory 10 and displayed on the screen 37.

After confirming that there is no error in the entered purchaser name and password, the purchaser clicks the log-in button 42 by using the operation section 5. The screen control section 8 sends the purchaser name and password temporarily stored in the memory 10 to the server 3 via the line connection section 9 (step S15).

When the server 3 receives the purchaser name and password, the log-in section 29 (FIG. 3) performs the user authentication. Specifically, the log-in section 29 consults the table 14 (FIG. 4) in the DB 4 with the received purchaser name and password to determine whether there is a record including the received purchaser name and password in the table 14 or not.

When there is no corresponding record, a message indicating that there is no corresponding record is sent to the terminal 1 and displayed on the display section 6, and the log-in screen 37 is displayed again. On the contrary, when there is the corresponding record, the log-in section 29 determines that the access is an access from an authorized purchaser. The processing section 28 creates the table 20 (FIG. 8) for storing the ID cords on the memory 26, and stores the inquired purchaser name in the storage area of the purchaser in the created table 20.

Subsequently, the screen creating section 30 reads necessary information from the storage area 24 in the auxiliary storage 21, transfers it to the memory 26, reads the list of goods names held in the table 19 (FIG. 10) in the DB 4, transfers it to the memory 26, and creates the screen information of the screen 38 by using the read information. The screen creating section 30 transmits the created screen information to the corresponding terminal 1 via the line connection section 32 (step S17).

When the terminal 1 receives the screen information, the screen control section 8 (FIG. 2) displays the screen 38 (FIG. 18) onto the display section 6 on the basis of the received screen information (step S18). The purchaser refers to the displayed screen 38, and selects the name of goods the purchaser wishes to purchase from the list of goods names displayed in the display area 43 by using the operation section 5 (step S19). The selected goods name is temporarily stored in the memory 10.

After confirming that there is no error in the selected goods name, the purchaser clicks the goods selection button 44 by using the operation section 5. The screen control section 8 sends the goods name temporarily stored in the memory 10 to the server 3 via the line connection section 9 (step S20).

When the server 3 receives the goods name from the terminal 1, the processing section 28 of the purchaser information stores the received goods name into the storage area of the goods name in the table 20 (FIG. 8). The screen creating section 30 refers to the goods data (step S21). To be specific, the screen creating section 30 refers to the table 19 (FIG. 10) in the DB 4 and determines whether there is the file name corresponding to the received goods name or not. When there is no corresponding file name, a message indicating that there is no goods file to be purchased is sent to the terminal 1.

On the contrary, when there is the corresponding file name in the table 19, the screen creating section 30 reads the file name and transfers it to the memory 26. Subsequently, the screen creating section 30 reads necessary information from the storage area 24 in the auxiliary storage 21, transfers it to the memory 26, reads the goods file corresponding to the file name stored in the memory 26 from the storage area 25, transfers it to the memory 26, and creates the screen information of the screen 38 by using the read information. After that, the screen creating section 30 sends the created screen information to the corresponding terminal 1 via the line connection section 32 (step S22).

When the terminal 1 receives the screen information, the screen control section 8 (FIG. 2) displays the screen 39 (FIG. 19) onto the display section 6 on the basis of the received screen information (step S23). The purchaser refers to the displayed screen 39 and enters the ID code of the goods data the purchaser wishes to purchase into the entry box 46 by using the operation section 5 (step S24). The entered ID code is temporarily stored in the memory 10.

Subsequently, after confirming that there is no error in the entered ID code, the purchaser clicks the selection button 47 by using the operation section 5 (step S25). The screen control section 8 sends the ID code temporarily stored in the memory 10 to the server 3 via the line connection section 9.

When the server 3 receives the ID code, the processing section 28 updates the table 20 on the memory 26. That is, the processing section 28 stores the received ID code in to the storage area of the ID code in the table 20 (FIG. 8).

After that, the server 3 enters a aspect of waiting for the ID code or a quotation request made by clicking the quotation button 48 from the terminal 1. Meanwhile, after transmitting the ID code selected by the click on the selection button 47, the terminal 1 enters a aspect of waiting for the entry of the ID code or the click on the quotation button 48 by the purchaser.

Consequently, when the purchaser selects and enters the ID code of another goods data again and clicks the selection button 47, the selected ID code is sent to the server 3 and is stored in the table 20. That is, by repeating the operations in steps S24 and S25, the purchaser can selects one or more pieces of goods data per purchase.

When the purchaser selects all of goods data to be purchased this time and clicks the selection button 47, the ordered goods of the purchase of this time are stored in the table 20. After that, the purchaser clicks the quotation button 48 by using the operation section 5. The screen control section 8 sends the inquiry to the server 3 via the line controller 9 (step S27).

When the server 3 receives the inquiry, the price calculation section 31 (FIG. 3) quotes the price of the order of this time (step S28). Specifically, the price calculation section 31 refers to the table 15 (FIG. 5) in the DB 4, reads a purchase record (cumulative total of the number of external character fonts already purchased) in the purchase record including the purchaser name and the goods name stored in the table 20, and stores it to the memory 26. For example, when the purchaser name is “A Company” and the goods name is “Ming-cho type” as shown in FIG. 5, the purchase record of “150 [characters]” is read from the purchase record table 15 and is stored into the memory 26.

The price calculation section 31 calculates the purchase price by using the data held in the table 16 (FIG. 6) and the data held in the table 20 (FIG. 8). Specifically, the price calculation section 31 refers to the table 20 and obtains the total number of ID codes selected in the order of this time.

The price calculation section 31 adds the obtained total number to the read purchase record, and calculates the range of characters (kinds) to which the goods data to be purchased this time applies. For example, when the number of ID codes (the number of characters) held in the table 20 is 100, from the calculation that the purchase record (150 [characters])+100 [characters]=250 [characters], it is calculated that the goods data purchased this time corresponds to the range from the 151st character to the 250th character.

The price calculation section 31 refers to the table 16, obtains the unit application range to which the goods data to be purchased this time belongs, and calculates the unit applied to the goods data.

In the above example, the goods data corresponding to the range from the 151st character to the 200th character belongs to the application range (from the 101st character to the 200th character) in which the unit is 700 yen. Consequently, the unit of 50 pieces out of 100 pieces of the goods data is 700 yen. The goods data corresponding to the range from the 201st character to the 250th character belongs to the application range (from the 201st character to the 300th character) in which the unit is 500 yen. The unit of the rest of the 50 pieces of the goods data is 500 yen.

The price calculation section 31 calculates the purchase price of the order of this time by using the obtained unit and the number of goods data to which the unit is applied. In the example, the price calculation section 31 calculates the purchase price as (700 [yen]×50 [characters])+(500 [yen]×50 [characters])=60,000 [yen]. The price calculation section 31 stores the calculated purchase price into the memory 26.

After the purchase price is calculated, the screen creating section 30 reads the necessary information from the storage area 24, stores it to the memory 26, and creates the screen information of the quotation screen 40 by using the read information and the information already stored in the memory 26 (goods name, purchase record, total number of goods data to be purchased this time, and purchase price). After that, the screen creating section 30 sends the created screen information to the corresponding terminal 1 via the line connection section 32 (step S29).

To store the contents of the order, the screen creating section 30 stores a new supply information record including the purchaser name and goods name stored in the table 20 and the purchase price stored in the memory 26 into the table 18 (FIG. 9), and clears the payment flag corresponding to the stored supply information record to “unpaid”.

When the terminal 1 receives the screen information, the screen control section 8 (FIG. 2) displays the quotation screen 40 (FIG. 16) onto the display section 6 on the basis of the received screen information (step S30). The purchaser refers to the displayed quotation screen 40 and can grasp that the unit of the goods data is reduced according to the purchase record and the goods data has become reasonable.

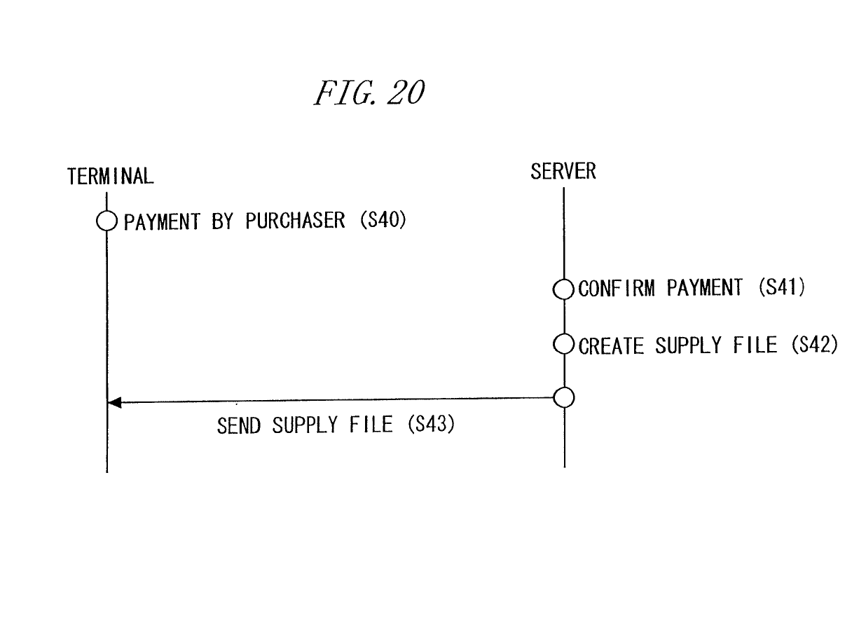

FIG. 20 is a sequence chart showing the details of the payment (phase F6) and supply (phase F7) indicated in FIG. 17. In FIG. 20, when the purchaser referred to the quotation screen 40 acknowledges the quotation price and purchases the goods data, the purchaser pays the price to the seller of the goods (step S40).

The payment is made by, as described above, transfer of money to a financial institute by the purchaser, by remittance, or by credit card. That is, any of the payment methods used in what is called net sales can be applied.

In the example, the purchaser transfers money to the account of the seller in a financial institute. A computer in the financial institute sends a notification of receipt of the money (payment notification) to the server 3 by an E-mail. The payment notification includes the purchaser name, goods name, and purchase price (amount of transfer).

When the server 3 receives the E-mail of the payment notification, the payment status checking section 34 (FIG. 3) in the server 3 refers to the payment notification and confirms receipt of the money (step S41). That is, the payment status checking section 34 detects the purchaser name, goods name, and purchase price included in the payment notification.

Subsequently, the payment status checking section 34 refers to the supply information table 18 (FIG. 9) in the DB 4 and retrieves a supply information record including the same purchaser name, goods name, and purchase price as the detected purchaser name, goods name, and purchase price. When the corresponding supply information record is retrieved, the payment status checking section 34 regards that the payment regarding the supply information record has been paid, and sets the payment flag of the supply information record as “paid”.

Then the supply section 35 recognizes that the payment flag of the supply information record is set as “paid”, and obtains the purchaser name and the ID code of one or more goods data corresponding to the goods name included in the supply information record from the table 20 (FIG. 8).

Subsequently, the supply section 35 creates a file for storing the goods data corresponding to one or more ID code(s) obtained from the table 20 as a supply file, and sets an arbitrary file name (“adsd1.ttf” in the example shown in FIG. 9).

The supply section 35 copies the goods data corresponding to the one or more ID code(s) corresponding co the purchase of this time from a corresponding goods file (goods file 25A in the example) held in the storage area 25 in the auxiliary storage 21, and stores it into the supply file. The supply file created in such a manner is stored in the storage area 22 in the auxiliary storage 21.

In parallel with the above process, the supply section 35 refers to the table 17 (FIG. 7) including the purchaser name and goods name included in the supply information record, and sets a purchase flag corresponding to the ID code of the goods data included in the supply file as “purchased”.

In the case where this is the first purchase of the purchaser, the table 17 corresponding to the purchaser name and goods name included in the supply information record is newly created, and the purchase flag corresponding to the ID code of the one or more goods data included in the supply file is set as “purchased”.

After that, the supply section 35 sends the supply file stored in the storage area 22 to the corresponding terminal 1 via the line connection section 32 voluntarily or in response to a request from the terminal 1 (step S43).

For example, the supply section 35 creates an E-mail to which the supply file is attached as an attached file, and sends the E-mail with the attached file to the E-mail address of the purchaser stored in the table 14 (FIG. 4) as a destination.

Alternately, the supply section 35 notifies the terminal 1 of address information (URL) necessary for the terminal 1 to download the supply file. After that, the server 3 transmits the supply file to the terminal 1 in response to a download request from the terminal 1.

When the purchaser pays the price by using the payment method of transfer to a bank of the seller or the like, in step S41, in place of the above-described process, the manager (seller) of the server 3 confirms the payment of the purchaser, refers to the data in the table 18 by using the display section 12 and the operation section 11, and sets the payment flag of the corresponding supply information record as “paid”.

Alternately, the supply section 35 notifies the purchaser of the URL of the supply screen 50 (refer to FIG. 29). The supply screen 50 is an operation screen used by the purchaser to operate the terminal 1 to download the supply file stored in a DB.

The URL of the supply screen 50 may be notified by displaying it on the Web page or sending it to the purchaser by an E-mail. The URL of the supply screen 50 may be notified by other transmitting methods (telephone and letter).

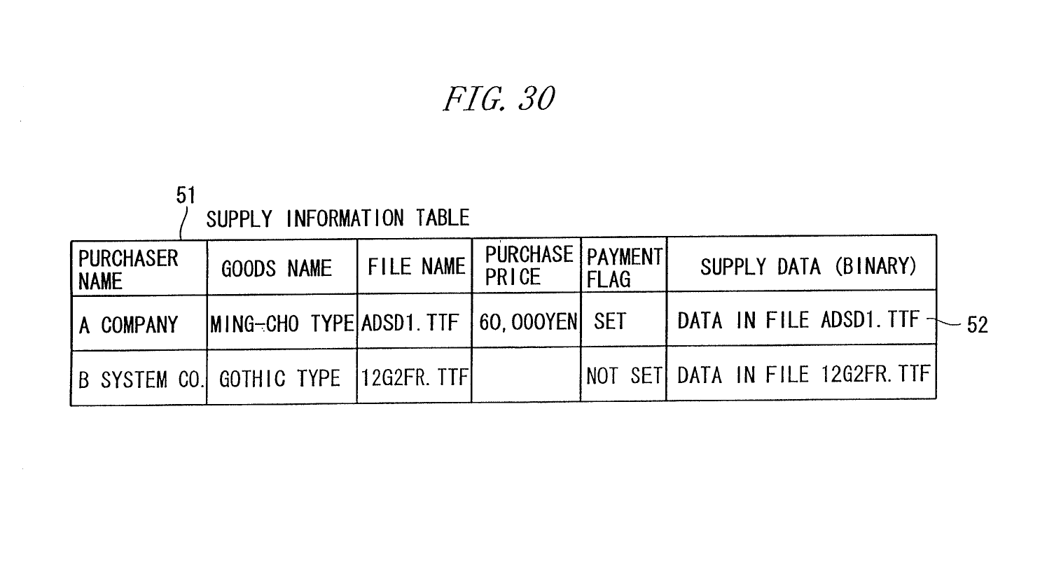

The supply section 35 stores the supply file not in the supply file storage area 22 but in the supply data field 52 in the table 51 (refer to FIG. 30) as a DB.

After that, the purchaser accesses the notified URL by operating the terminal 1, is subjected to user authentication, and allows the supply screen 50 to be displayed on the display section 6. The purchaser downloads the supply file in accordance with data displayed on the supply screen 50.

On the supply screen 50, as shown in FIG. 29, the purchaser name, goods name, supply position, and supply file name are displayed. As the supply position, for example, file name information for accessing the DB (file name hyperlinked to the DB) is displayed.

In the example, as an explanation sentence, “file name is “adsd1.ttf”” is displayed on the supply screen 50. The explanation sentence is displayed in accordance with an HTML document such as “<A HREF=“download.asp?FILENAME=adsd1.ttf”>file name is “adsd1.ttf”<A>”.

When the purchaser clicks “file name is “adsd1.ttf”” displayed on the supply screen 50, a jump is made to an address-designed file as “download.asp?FILENAME=adsd1.ttf” by the hyperlink function of the HTML.

The file “download.asp” is described in the program language generally called a script so that an access can be made to a predetermined position in the DB and a data file is downloaded to the terminal 1 of the purchaser. Consequently, by the click, the supply file “adsd1.ttf” is read from the table 51 and sent to the terminal 1 of the purchaser.

As described above, it is also possible to dispose the supply file in the database connected to the network, and the purchaser may access the database by operating the terminal 1 to download the supply file.

Although the data in the table 20 is held until the supply file is created in the above example, when the period from transmission of the quotation screen 40 (step S29) until confirmation of the payment (step S41) is long, the data in the table 20 may be saved in the DB 4 or the auxiliary storage 21. The table 20 may be created on the DB 4 or the auxiliary storage 21.

In the system according to the first embodiment, the unit applied to each external character font is determined according to the number of external character fonts (goods data) to be purchased by the purchaser. In this case, as the number of the external character fonts increases, the cheaper unit is applied.

In such a manner, the purchase price of a number of external character fonts is reduced. The purchaser can therefore easily purchase a number of external character fonts. Unsuccessful sales due to high price can be therefore suppressed, and sales of external character fonts can be promoted.

In the embodiment, the server 3 has the purchase record of a purchaser, calculates the sum of the number (cumulative total) of external character fonts purchased in the past as the purchase record and the number of external character fonts in the purchase of this time, and obtains a unit applied to each of the external character fonts to be purchased this time in accordance with the result of addition.

By the arrangement, the purchase price in the case of purchasing a number of external character fonts at once and the purchase price in the case of purchasing a number of external character fonts in a plurality of times are the same when the total number of external character fonts to be purchased is the same. Since the purchase price is consequently fair, it can make the purchaser who does not have ample funds desire to purchase the external character fonts through the goods selling system.

As described above, in the embodiment, the sales price (that is, purchase price of the purchaser) of the goods designated as an object to be purchased is determined on the basis of the purchase record of the goods of the purchaser.

In place of the configuration of the embodiment, the supply file creating section 33 may create a supply file to which data of goods purchased by the purchaser in the past is added and supply the file.

Specifically, when one or more ID codes are obtained from the table 20, the supply file creating section 33 detects the table 17 in which the purchaser name and goods name stored in the table 20 are stored, and obtains one or more ID codes in which the purchase flag is set as “purchased” from the detected table 17.

Subsequently, the supply file creating section 33 creates a supply file including goods data corresponding to one or more ID codes obtained from the tables 20 and 17. That is, the supply file creating section 33 creates the supply file including not only one or more goods data to be purchased by the purchaser this time but also one or more goods data purchased in the past.

By supplying the above-described supply file to the purchaser, there are the following advantages. In the case where the purchaser purchases the external character font for the second time or thereafter, when the supply file including only one or more pieces of goods data to be purchased this time is supplied, in many cases, the purchaser cannot use the goods data included in the supply file of this time without combining the supply file of goods supplied in the past and the supply file supplied this time. That is, in many times, the supply file including one or more pieces of goods data purchased by an additional order cannot be used as it is.

When the server 3 supplies the supply file including all of the goods data the purchaser wishes to purchase, the purchaser can save himself/herself some work. As described above, by creating and supplying the convenient supply file by the server 3, the number of users of the system can be increased and the sales can be promoted.

Second Embodiment

A second embodiment of the invention will now be described. Since the second embodiment has commonality with the first embodiment, the different points will be mainly described. In the first embodiment, the external character file consisting of a variety of external character fonts is explained as an example of goods. In contrast, the second embodiment relates to a system for selling an electronic book consisting of a plurality of chapters as goods.

The network configuration of the system and configurations of the terminal 1 and the server 3 in the second embodiment are substantially the same as those of the first embodiment. As described hereinbelow, the data held in the tables in the DB 4 is different from that in the first embodiment.

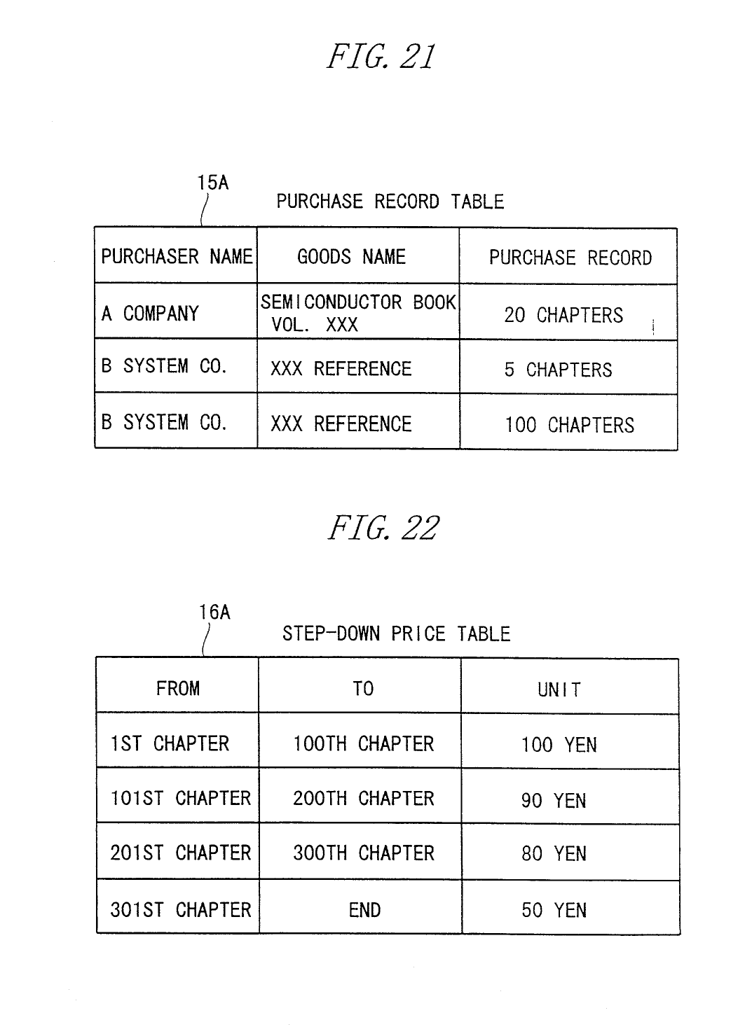

FIG. 21 is an explanatory diagram of a table 15A for storing a purchase record in the second embodiment. As shown in FIG. 21, the second embodiment is different from the first embodiment with respect to the points that the goods name is a book title and the purchase record denotes the number (cumulative total) of chapters purchased by the purchaser in the past.

FIG. 22 is an explanatory diagram of a table 16A for storing a step-down price in the second embodiment. As shown in FIG. 22, in a manner similar to the first embodiment, a plurality of unit application ranges are defined. In the second embodiment, the sections of the application start and application end for determining the application range are chapters.

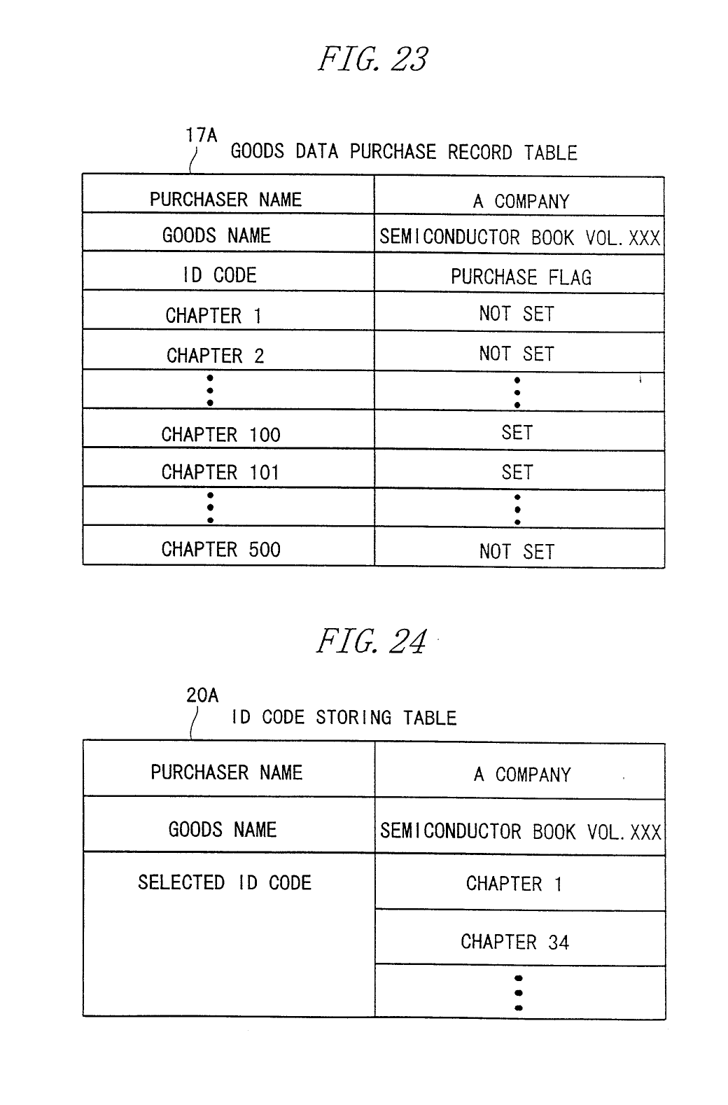

FIG. 23 is an explanatory diagram of a table 17A for storing a goods data purchase record in the second embodiment. As shown in FIG. 23, the second embodiment is different from the first embodiment with respect to the point that a purchase flag is set to the IC code assigned to each of the chapters of an electronic book.

FIG. 24 is an explanatory diagram of a table 20A for storing the ID code in the second embodiment. As shown in FIG. 24, the second embodiment is different from the first embodiment with respect to the point that the ID code (chapter number) of one or more chapters purchased this time is stored.

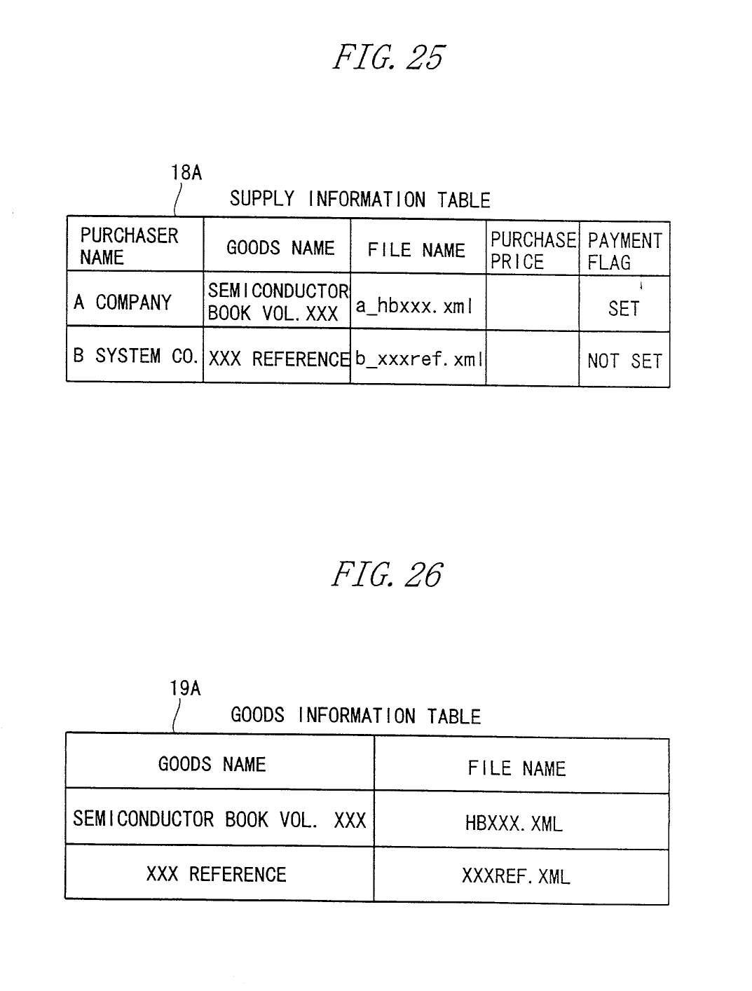

FIG. 25 is an explanatory diagram of a table 18A for storing supply information in the second embodiment. As shown in FIG. 25, different from the first embodiment, the goods name is a book title.

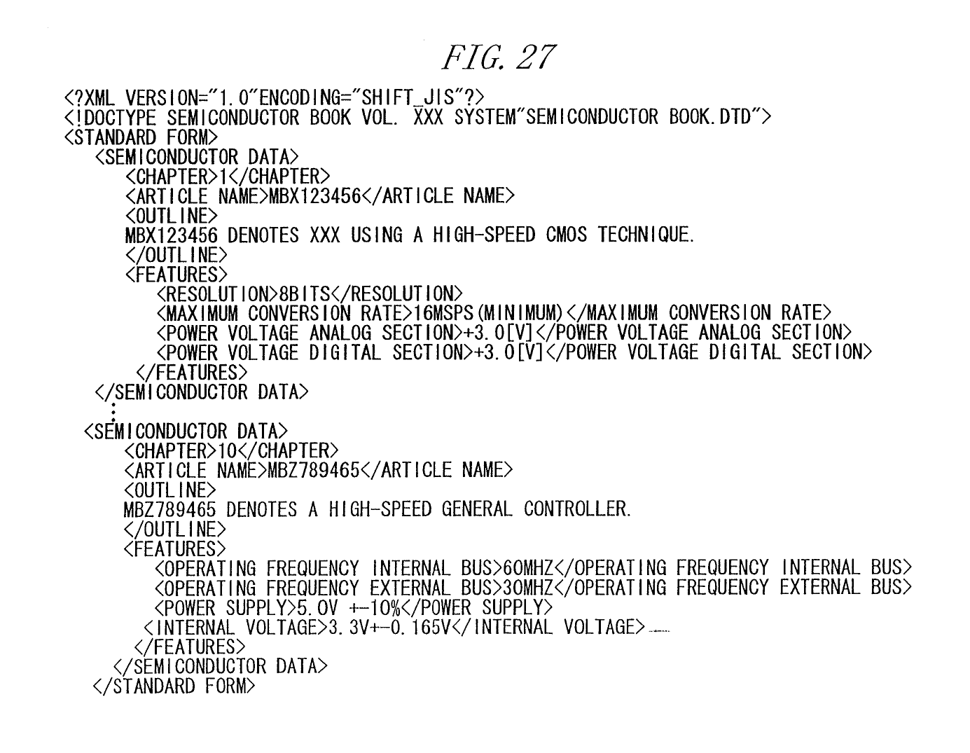

FIG. 26 is an explanatory diagram of a table 19A for storing goods information in the second embodiment. As shown in FIG. 26, the second embodiment is different from the first embodiment with respect to the point that the goods name is a book title.

FIG. 27 is an explanatory diagram of a book file to be stored in the storage area 25. The book file has a file structure generally called XML. An XML file having a file name corresponding to the goods name is prepared, and the XML file is described in a format so that data can be managed on a chapter section basis.

FIG. 27 shows the book file of the goods name “Semiconductor Book Vol. xxx (file name: hdxxx.xml)”. A supply file (file name: a_hbxxx.xml) including data of the chapters desired to be purchased by the purchaser is created by using the book file.

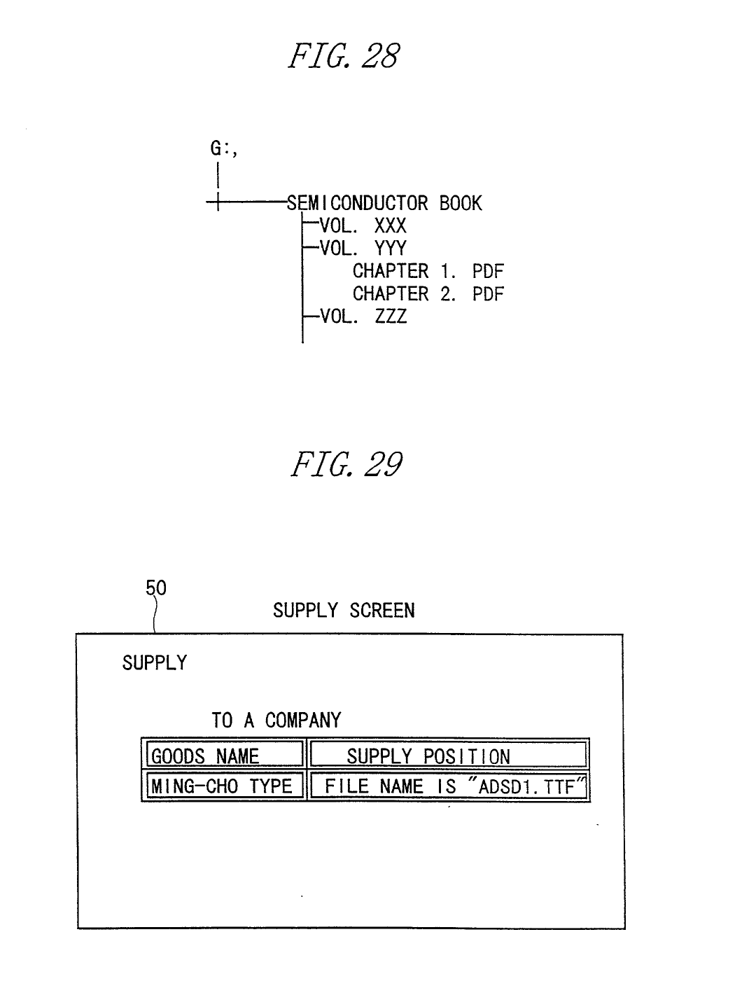

FIG. 28 is an explanatory diagram showing another example of a book file. In the example shown in FIG. 28, a directory tree of information such as book title and volume is created on a recording medium (device recognized as a “G” drive in FIG. 28), and a file including electronic data of each chapter is stored in each directory.

In this case, as the goods file name and the supply file name, a file name including file names of a plurality of chapters, a directory name of a directory which stores files of a plurality of chapters, an archive file obtained by merging a plurality of chapter files, and the like are used.

The processes at the time of purchase are substantially the same as those of the first embodiment (refer to FIGS. 17 to 20). The operation screens provided to the terminal 1 are the same as those shown in FIGS. 12 to 16 except for the point that “character” in the screens shown in FIGS. 12 to 16 is changed to “chapter”.

An example that a purchaser “A company” purchases 90 chapters (90 kinds of chapters) from a goods name “Semiconductor Book Vol. xxx” will be described hereinbelow. In step S28 (FIG. 19), the price calculation section 31 reads the number of chapters to be purchased this time from the table 20A (FIG. 24). When the purchase of this time is the first purchase, the price calculation section 31 obtains the unit applied to the chapters to be purchased by using the table 16A (FIG. 22), and calculates the purchase price by using the obtained unit. In this case, the purchase price is calculated as 90 [chapters]×100 [yen]=9,000 [yen].

When the purchase of this time is the second time or thereafter, the price calculation section 31 reads the purchase record (20 chapters) from the table 15A (FIG. 21), adds the purchase record to the purchase of this time (90 chapters), and calculates a purchase price by using the addition result and the table 16A. In this case, the purchase price is calculated as 80 [chapters]×100 [yen]+10 [chapters]×90 [yen]=8,900 [yen].

The processes from the payment to supply are substantially the same as those of the first embodiment. When the payment flag of the corresponding supply information record in the table 18A is set as “paid” in association with the payment by the purchaser, the supply file creating section 33 creates the supply file on the basis of the table 20A having data matching the purchaser name and goods name included in the supply information record. At this time, a supply file including one or more chapters to be purchased this time and one or more chapters purchased in the past may be created and supplied.

As described above, the second embodiment can produce effects similar to those of the first embodiment.

According to the invention, by properly storing a transaction state (purchase record) of the purchaser in the database, goods sales very convenient for the purchaser when an additional order is made can be provided.

The configuration described in the first embodiment can be combined with the second embodiment as appropriate in a range where the object of the invention can be achieved.

The goods of the invention is not limited to elements of a data set but can be applied to sales of general devices, goods, and electronic data (including application programs).

What is claimed is:

1. A system for selling goods through a network, the goods being a variety of elements which are different from each other and are sold one by one, the system comprising:
a unit storage section storing a unit of the variety of elements according to the number of the elements and ranges to each of which a unit is applied;
a detecting section detecting the number of elements to be purchased on the basis of information of one or more elements to be purchased which is received from a purchaser;
a reading section reading at least one unit applied to the element to be purchased on the basis of the number of element detected from the unit storage section;
a first calculating section calculating the number of elements belonging to a range to which the read at least one unit is applied; and
a second calculating section calculating the purchase price by using the read at least one unit and the number of elements calculated.

2. A system according to claim 1 further comprising:
a purchase record storage section storing the number of elements purchased by the purchaser in the past; and
an addition section reading the number of elements purchased in the past from the purchase record storage section when the number of elements is detected by the detecting section, and adding the read number to the detected number,
wherein the reading section reads at least one unit applied to the element to be purchased from the unit storage section by using a result of addition by the addition section.

3. A system according to claim 1 wherein the goods denotes a set of data as the elements, and
the system further comprises:
a data storage section storing a set of the data;
a creating section creating a supply file including data corresponding to information of the elements to be purchased by using the set of data stored in the data storage section; and
a supplying section supplying the created supply file to the purchaser.

4. A system according to claim 3 wherein the creating section creates a supply file further including data purchased by the purchaser in the past.

5. A system according to claim 3 wherein the set of data is font set data, and
a piece of the data is font data as an element of the font set data.

6. A system according to claim 3 wherein the set of data is data of sentences divided every predetermined range, and
the data is data in each of the ranges constructing data of the sentences.

7. A system for a purchaser to purchase goods through a network, the goods being a variety of elements which are different from each other and are sold one by one, the system comprising:
a transmitting section transmitting information of one or more elements to be purchased to a seller;
a receiving section receiving a price of the element to be purchased, which is calculated by using at least one unit of an element determined on the basis of the number of elements to be purchased and a range to which the unit is applied; and
a display controlling section displaying the received price onto a display.

8. A system according to claim 7 wherein the receiving section receives a price of the element to be purchased, which is calculated by using at least one unit of an element determined on the basis of a result of addition between the number of elements to be purchased and the number of elements purchased in the past by the purchaser.

9. A system according to claim 7 wherein the goods denote a set of data as the elements, and
the receiving section receives a supply file including data corresponding to information of the element to be purchased.

10. A system according to claim 9 wherein the receiving section receives a supply file further including data purchased in the past by the purchaser.

11. A goods selling system having a client and a server connected to the client through a network, the goods being a variety of elements which are different from each other and are sold one by one,
the client comprising:
a transmitting/receiving section transmitting information of one or more elements to be purchased; and
a display controlling section displaying a received purchase price onto a display, the purchase price being received by the transmitting/receiving section from the server as a price of the element to be purchased, and
the server comprising:
a unit storage section storing units of the variety of elements in accordance with the number of elements;
a second transmitting/receiving section receiving information of the element and transmitting the purchase price;
a detecting section detecting the number of elements to be purchased on the basis of the information of the element;
a reading section reading at least one unit applied to the element to be purchased on the basis of the detected number of element(s) from the unit storage section;
a first calculating section calculating the number of elements belonging to a range to which the read at least one unit is applied; and
a second calculating section calculating the purchase price by using the read at least one unit and the number of calculated element(s).

12. A computer readable medium on which a program for allowing a computer to execute a process of selling goods through a network is recorded, the goods being a variety of elements which are different from each other and are sold one by one,
the program comprising:
a step of storing a unit of the variety of elements according to the number of the elements
a step of detecting the number of elements to be purchased on the basis of information of one or more elements to be purchased which is received from a purchaser;
a reading step of reading at least one unit applied to the element to be purchased on the basis of the number of element detected;
a step of calculating the number of elements belonging to a range to which the at least one read unit is applied; and
a step of calculating the purchase price by using the read at least one unit and the number of elements calculated.

13. A computer readable medium according to claim 12 wherein the program further comprises:
a step of storing the number of elements purchased by the purchaser in the past;
a step of reading the number of elements purchased in the past when the number of elements is detected, and adding the read number to the detected number; and
a step of reading at least one unit applied to the element to be purchased by using a result of the addition from the unit storage section.

14. A computer readable medium according to claim 12 wherein the goods denotes a set of data as the elements, and
the program further comprises:
a step of storing a set of the data;
a step of creating a supply file including data corresponding to information of the elements to be purchased by using the set of data stored; and
a step of supplying the created supply file to the purchaser.

15. A computer readable medium according to claim 14 wherein the step of creating the supply file creates a supply file further including data purchased by the purchaser in the past.

16. A computer readable medium in which a program for allowing a computer to execute a process for a purchaser to purchase goods through a network is recorded, the goods being a variety of elements which are different from each other and are sold one by one, the program comprising:
a step of transmitting information of one or more elements to be purchased to a seller;
a step of receiving a price of the element to be purchased, which is calculated by using at least one unit of an element determined on the basis of the number of elements to be purchased and a range to which the unit is applied; and
a step of displaying the received price onto a display.

17. A computer readable medium according to claim 16 wherein the program further comprises:
a step of receiving a price of the element to be purchased, which is calculated by using at least one unit of an element determined on the basis a result of addition between the number of elements to be purchased and the number of elements purchased in the past by the purchaser and a range to which the unit is applied.

18. A computer readable medium according to claim 16 wherein the goods denote a set of data as the elements, and
the program further comprises a step of receiving a supply file including data corresponding to information of the element to be purchased.

19. A computer readable medium according to claim 18 wherein the program further comprising a step of receiving a supply file further including data purchased in the past by the purchaser.

20. A system for selling goods through a network, comprising:
a storage section storing a goods purchase record of a purchaser; and
a calculating section calculating a purchase price of goods to be purchased which is received from the purchaser on the basis of the purchase record of the purchaser stored in the storage section.

21. A system according to claim 20 wherein the calculating section calculates the purchase price of the goods to be purchased on the basis of a quantity of goods in the purchase record and a quantity of the goods to be purchased.

22. A system according to claim 21 further comprising:
a unit storage section storing units of the variety of goods according to the quantity of goods and a range to which each unit is applied, and
wherein the calculating section calculates the purchase price of the goods to be purchased by obtaining the application range to which the goods to be purchased belongs and the quantity of the goods to be purchased on the basis of a sum of a quantity of goods in the purchase record and the quantity of goods to be purchased.

23. A system for selling goods through a network, comprising:
a transmitting section transmitting information of goods to be purchased which is designated by a purchaser to a seller;
a receiving section receiving a purchase price of the goods to be purchased, which is determined on the basis of a purchase record of the purchaser in the past; and
a display controlling section displaying the received price onto a display.

24. A goods selling system having a client and a server connected to the client through a network,
the client comprising:
a transmitting section transmitting information of goods to be purchased which is designated by a purchaser to the server;
a receiving section receiving a purchase price of the goods to be purchased from the server; and
a display controlling section displaying the received price onto a display, and
the server comprising:
a purchase record storage section storing a goods purchase record of the purchaser; and
a calculating section calculating a purchase price of the goods to be purchased, which is received from the client on the basis of the purchase record of the purchaser stored in the purchase record storage section.

25. A computer readable medium on which a program for allowing a computer to execute a process for selling goods through a network is recorded, the program comprising:
a step of identifying a purchaser of goods;
a step of obtaining a goods purchase record of the purchaser; and
a step of calculating a purchase price of goods to be purchased which is received from the purchaser on the basis of the purchase record.

26. A method for selling goods through a network, comprising:
identifying a purchaser of goods;
obtaining a goods purchase record of the purchaser; and
calculating a purchase price of goods to be purchased which is received from the purchaser on the basis of the purchase record.
